(19) United States
(12) Patent Application Publication
(10) Pub. No.: US 2015/0351202 A1
(43) Pub. Date: Dec. 3, 2015

(54) MASTER-SLAVE CONTROL ARRANGEMENT FOR A LIGHTING FIXTURE

(71) Applicants: Melvin C. Cosby, Jr., Grand River, OH (US); Timothy Chen, Aurora, OH (US)

(72) Inventors: Melvin C. Cosby, Jr., Grand River, OH (US); Timothy Chen, Aurora, OH (US)

(73) Assignee: TECHNICAL CONSUMER PRODUCTS, INC., Aurora, OH (US)

(21) Appl. No.: 14/290,557

(22) Filed: May 29, 2014

(51) Int. Cl. H05B 37/02; H05B 33/08

(52) U.S. Cl. CPC H05B 37/0272; H05B 33/0815; H05B 33/0845; H05B 37/0254

(57) ABSTRACT

A lighting fixture is disclosed, and includes a plurality of lighting arrays, a master power module, a data communications link, and at least one slave power module. The master power module provides power and control to one of the plurality of lighting arrays, and transmits a control signal. The data communications link transmits the control signal. The slave power module provides power and control to another one of the plurality of lighting arrays based on the control signal from the master power module. The data communications link connects the master power module to the slave power module.

### TECHNICAL FIELD

The present disclosure relates generally to a lighting fixture, and more particularly to a lighting fixture including a master power module and at least one slave power module connected to one another by a data communications link.

### BACKGROUND

A troffer is a specific type of lighting fixture. A troffer may be installed within a suspended ceiling grid system, where one or more ceiling tiles are replaced with the troffer. Thus, the exterior dimensions of the troffer may fit within the regular spacing of the ceiling tiles. For example, some types of troffers may be two feet by two feet, or two feet by four feet. The troffer typically houses one or more lighting arrays for providing illumination to a desired area. For example, the lighting array may be a fluorescent tubes. Alternatively, the lighting array may be an array of multiple light emitting diodes (LEDs).

In one approach, each lighting array may include its own power supply module. Specifically, each power supply module may include power electronics as well as radio frequency (RF) electronics. The power electronics may be used to deliver power to a specific one of the lighting arrays. The RF electronics my include, for example an antenna element as well as a controller or microcontroller. The antenna element may be used for wireless communication. For example, a user may turn on, turn off, or dim a troffer using wireless control. The microcontroller may be used to control illumination of the lighting array. A troffer typically includes multiple lighting arrays, where each lighting array includes its own power supply module. Thus, the troffer may include numerous antennas and microcontrollers therein. Providing multiple antennas and microcontrollers within a troffer may be expensive, and also adds complexity to the overall design of the troffer as well. Thus, there exists a continuing need in the art for cost-effective lighting fixtures.

### SUMMARY

In one embodiment, a lighting fixture is disclosed, and includes a plurality of lighting arrays, a master power module, a data communications link, and at least one slave power module. The master power module provides power and control to one of the plurality of lighting arrays, and transmits a control signal. The data communications link transmits the control signal. The slave power module provides power and control to another one of the plurality of lighting arrays based on the control signal from the master power module. The data communications link connects the master power module to the slave power module.

In another embodiment, a light emitting diode (LED) lighting fixture is disclosed. The LED lighting fixture includes a plurality of LED lighting arrays, a master power module, a data communications link, and at least one slave power module. The master power module provides power and control to one of the plurality of lighting arrays. The master power module includes a microcontroller and an antenna element. The microcontroller transmits a control signal. The data communications link transmits the control signal. The control signal includes at least one of an on signal, an off signal, and a dimming signal. The slave power module provides power and control to another one of the plurality of lighting arrays based on the control signal from the master power module. The data communications link connects the master power module to the slave power module.

### BRIEF DESCRIPTION OF THE DRAWINGS

FIG. 1 is an exemplary schematic diagram of a lighting fixture having a master power module and at least one slave power module;

FIG. 2 is an illustration of two driver boards associated with the master power module;

FIG. 3 is an illustration of two driver boards associated with the slave power module;

FIG. 4 is a circuit diagram illustrating a microcontroller of the master power module and slave interface circuitry of the slave power module;

FIG. 5 is an alternative embodiment of the circuit diagram shown in FIG. 4;

FIG. 6 is a yet another embodiment of the circuit diagram shown in FIG. 4; and

FIG. 7 is a circuit diagram illustrating slave interface circuitry of the slave power module.

### DETAILED DESCRIPTION

The following detailed description will illustrate the general principles of the invention, examples of which are additionally illustrated in the accompanying drawings. In the drawings, like reference numbers indicate identical or functionally similar elements.

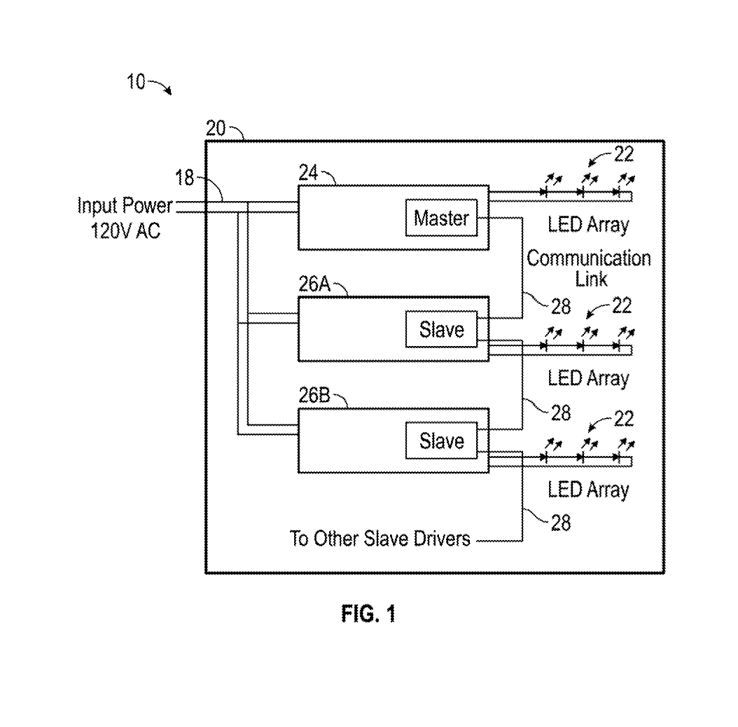

FIG. 1 is an exemplary schematic diagram of a lighting fixture 10. The lighting fixture 10 may include a housing 20. The housing 20 may include a generally square or rectangular profile. A plurality of lighting arrays 22 and a plurality of power supply modules 24, 26A, and 26B may be located within the housing 20 of the lighting fixture 10. In the non-limiting embodiment as shown, the lighting arrays 20 are each composed of a plurality of light emitting diodes (LEDs) and the lighting fixture 10 is an LED light. However, those skilled in the art will appreciate that other types of lighting arrays 20 may be used as well. For example, in an alternative embodiment, each lighting array 20 may be a fluorescent light tube.

Each of the power supply modules 24, 26A and 26B may be connected to an incoming supply of power 18 such as, for example, main power lines at a nominal 120 volts AC. In one approach, the lighting fixture 10 may be a troffer, however it is to be understood that other types of lighting fixtures may be employed as well. The power supply module 24 is a main or master power module that provides power and control to one of the lighting arrays 20. The remaining power supply modules 26A, 26B are slave power modules that are driven by the master power module 24. A data communications link 28 may be used to connect the master power module 24 to the slave power module 26A. Additionally, the data communications link 28 may also be used to connect the slave power module 26A to the slave power module 26B. The data communications link 28 may be any type of wired communications link that transmits an analog or digital control signal between the power supply modules 24, 26A, and 26B such as, for example, a multi-conductor cable. The control signal may be used to control the lighting arrays 20 associated with the slave power modules 26A, 26B. For example, the control signal may cause the slave power modules 26A, 26B to dim, change color, turn on, or turn off an associated lighting array 20.

Although FIG. 1 illustrates the master power module 24 connected to the slave power module 26A and the slave power module 26A connected to the slave power module 26B using the data communications link 28, it is to be understood that in an alternative embodiment the master power module 24 may be connected to both of the slave power modules 26A, 26B using the data communications link 28 as well.

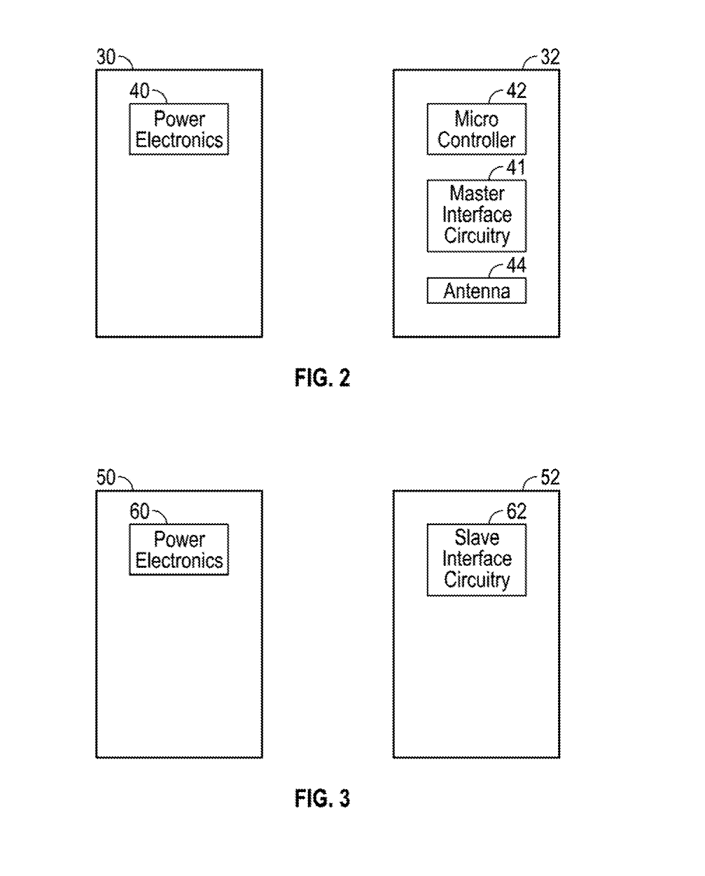

FIG. 2 is an exemplary illustration of a first driver board 30 and a second driver board 32 located within the master power module 24 shown in FIG. 1. In one embodiment, the driver boards 30, 32 may be a printed circuit board (PCB), however it is to be understood that the disclosure is not limited to a PCB. The first driver board 30 may include various power electronics 40 that are electrically coupled and deliver power to a corresponding one of the lighting arrays 20 (FIG. 1).

The second driver board 32 may include master interface circuitry 41, a controller or microcontroller 42 and an antenna element 44. The master interface circuitry 41 may be used to transmit the control signal between the master power module 24 and the slave power module 26A (FIG. 1), and is described in greater detail below. The microcontroller 42 may refer to, be part of, or include an electronic circuit, a combinational logic circuit, a field programmable gate array (FPGA), a processor (shared, dedicated, or group) that executes code, other suitable components that provide the described functionality, or a combination of some or all of the above, such as in a system-on-chip. The term module may include memory (shared, dedicated, or group) that stores code executed by the processor. The term code, as used above, may include software, firmware, or microcode, and may refer to programs, routines, functions, classes, or objects.

In one embodiment, the antenna element 44 may be a trace antenna. However, those skilled in the art will appreciate that the disclosure is not limited to a trace antenna. Although only one antenna element 44 is discussed, those skilled in the art will readily appreciate that more than antenna element may also be included on the driver board 32 as well in order to receive RF signals of varying frequencies. Alternatively, in another embodiment, the antenna element 44 may be a multi-band antenna that operates at different RF frequency bands. The master power module 24 (FIG. 1) may receive RF signals using the antenna element 44. For example, a user may manipulate a portable electronic device (not illustrated) such as a smartphone or tablet to wirelessly control the lighting fixture 10 (FIG. 1). The antenna element 44 located within the master power module 24 is configured to wirelessly communicate with the portable electronic device.

FIG. 3 is an exemplary illustration of a first driver board 50 and a second driver board 52 located within each slave power module 26A, 26B. Similar to the embodiment as shown in FIG. 2, the driver boards 50, 52 may be PCBs. The first driver board 50 may include various power electronics 60 that are electrically coupled and deliver power to a corresponding one of the lighting arrays 20 (FIG. 1). The second driver board 52 may include slave interface circuitry 62. The slave interface circuitry 62 may be used to transmit the control signal between various slave power modules (e.g., between slave power module 26A and 26B shown in FIG. 1), and is described in greater detail below. It should be noted that the slave power modules 26A, 26B do not include a controller or a microcontroller. Instead, the microcontroller 42 shown in FIG. 2 supplies the requisite control signal.

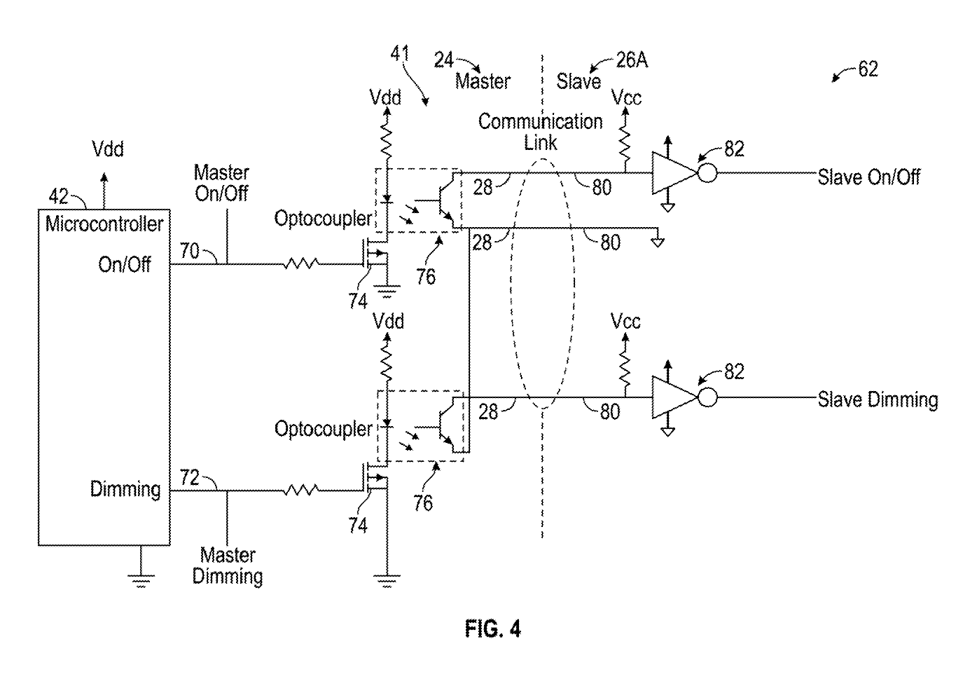

FIG. 4 is an exemplary circuit diagram illustrating the master interface circuitry 41 and the microcontroller 42 of the master power module 24 (FIG. 1), and the slave interface circuitry 62 of the slave power module 26A. In the non-limiting embodiment as shown in FIG. 4, the microcontroller 42 may generate two control signals, namely an on/off signal 70 as well as a dimming signal 72. Although a separate on/off signal 70 and dimming signal 72 are illustrated, those skilled in the art will appreciate that the illustration shown in FIG. 4 is merely exemplary in nature. For example, in an alternative embodiment, the microcontroller 42 may produce a control signal for changing the color of the lighting arrays 20 (FIG. 1).

The master interface circuitry 41 of the master power module 24 may include isolation electronics for suppressing or reducing the amount of electromagnetic interference in the on/off signal 70 and the dimming signal 72. The isolation electronics may also be used to provide static discharge and protection to the microcontroller 42 as well. Specifically, in the embodiment as shown, the master power module 42 may include a switching element 74 and an optocoupler 76 for providing electrical isolation to either the on/off signal 70 OR the dimming signal 72. The switching element 74 may be, for example, a metal-oxide-semiconductor field-effect transistor (MOSFET). However it is to be understood that other types of switching elements may be used as well. In the exemplary embodiment as shown, the optocoupler 76 may include an LED and a phototransistor, however it is to be understood that FIG. 4 is merely exemplary in nature, and that other types of optocouplers utilizing various components may be used as well. Those skilled in the art will readily appreciate that the optocouplers 76 inverts the on/off signal 70 and the dimming signal 72 from the master power module 24.

The data communications link 28 may be used to connect the output of the optocouplers 76 with the slave power module 26A. In the embodiment as shown, the slave interface circuitry 62 of the slave power module 26A may include multiple inputs 80 for receiving the on/off signal 70, ground, or dimming signal 72 from the master power module 24. The slave interface circuitry 62 may include inverting elements 82 that are used to invert the on/off signal 70 or the dimming signal 72 from the master power module 24. In the embodiment as shown, the inverting elements 82 are NOT gates, however it is to be understood that other types of inverting elements may be used as well.

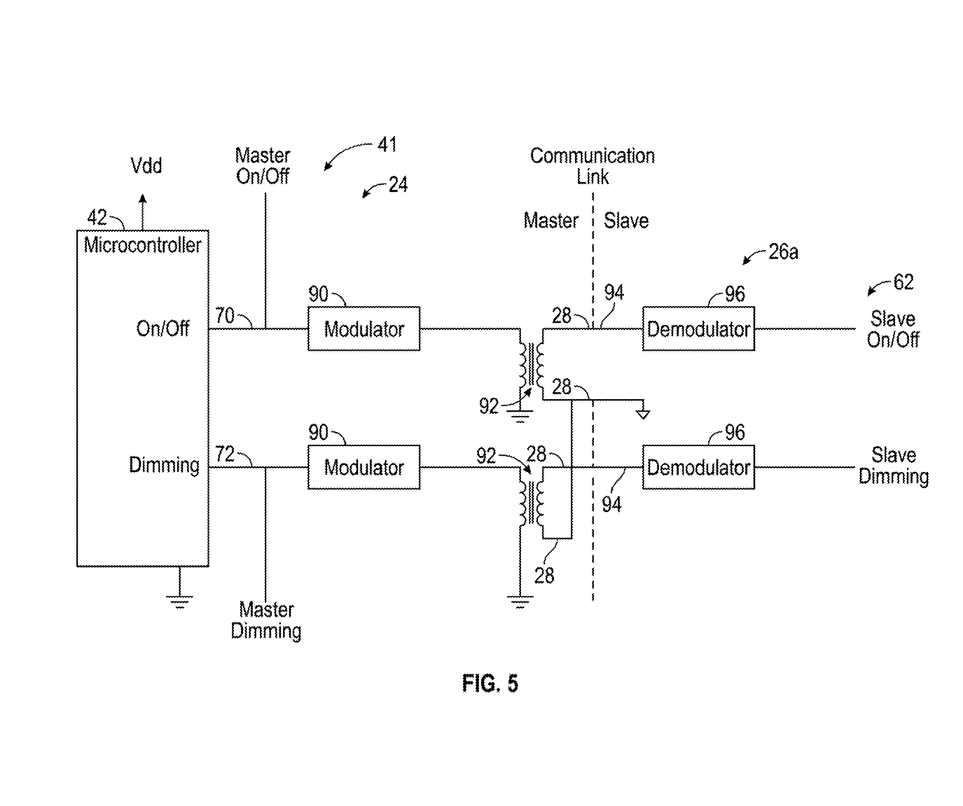

FIG. 5 is an alternative embodiment of the master power module 24 (FIG. 1), and the slave interface circuitry 62 (FIG. 3) of the slave power module 26A (FIG. 1). In the embodiment as shown in FIG. 5, the microcontroller 42 generates the on/off signal 70 and the dimming signal 72. However, the master interface circuitry 41 does not include the switching element 74 and the optocoupler 76 as seen in FIG. 4. Instead, the master interface circuitry 41 includes a modulator 90 and a magnetic transformer 92 for the on/off signal 70 and the dimming signal 72. The modulators 90 may be used to increase the frequency of the on/off signal 70 or the dimming signal 72 before being sent to a corresponding one of the magnetic transformers 92. Increasing the frequency of the on/off signal 70 and the dimming signal 72 will allow for the magnetic transformers 92 to be smaller in size, thereby reducing weight and material costs. In an embodiment, the magnetic transformer 92 may be a planar transformers that is integrated onto the board 32 (shown in FIG. 2). Specifically, in one embodiment the board 30 may be a multi-layer PCB, where the planar transformer is integrated into multiple layers of the PCB.

The data communications link 28 may be used to connect the output of the magnetic transformers 90 with the slave power module 26A. In the embodiment as shown, the slave interface circuitry 62 of the slave power module 26A may include multiple inputs 94 for receiving the on/off signal 70, ground, or dimming signal 72 from the master power module 24. The slave interface circuitry 62 may include demodulators 94 that are used to demodulate the on/off signal 70 or the dimming signal 72 from the master power module 24.

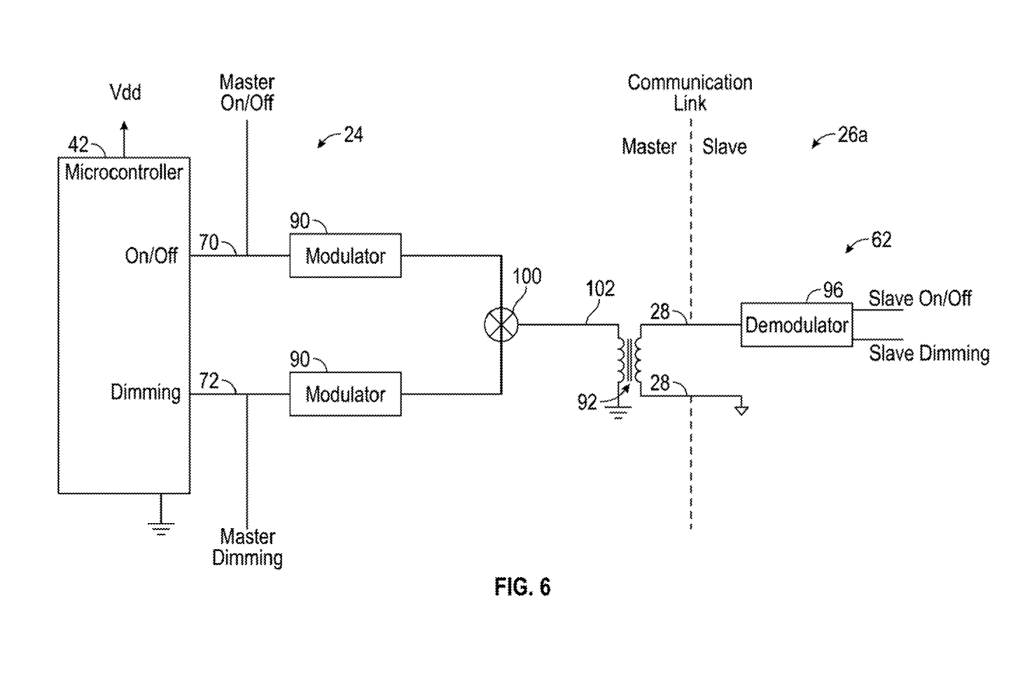

FIG. 6 is yet another embodiment of the master power module 24 (FIG. 1), and the slave interface circuitry 62 (FIG. 3) of the slave power module 26A (FIG. 1). In the embodiment as shown in FIG. 6, the master interface circuitry 41 may include a mixer 100 for receiving both the on/off signal 70 and the dimming signal 72 from the modulators 90. The mixer 100 may be used to combine the on/off signal 70 and the dimming signal 72 together. The mixer 100 may output a combined signal 102 that is sent to a single magnetic transformer 92. The data communications link 28 may be used to connect the output of the single magnetic transformer 92 with the slave power module 26A. In the embodiment as shown, the slave interface circuitry 62 of the slave power module 26A may include a single input 94 for receiving the combined signal 102 from the master power module 24. The slave interface circuitry 62 may include a single demodulator 96 used to demodulate the combined signal 102 from the master power module 24.

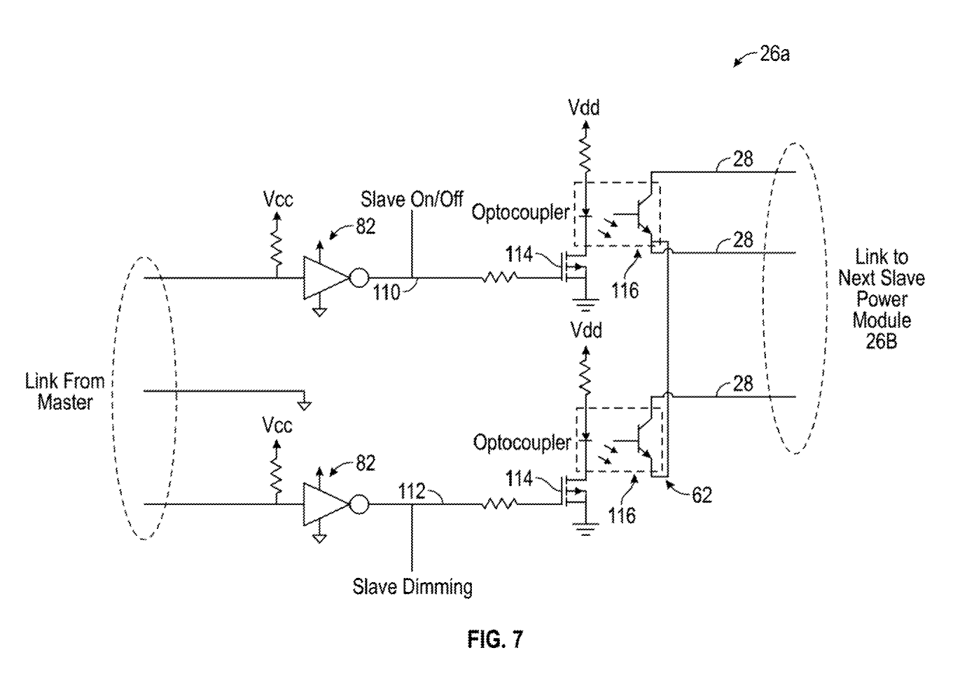

Referring to FIGS. 1, 3-4 and 7, the slave power module 26A is connected to the slave power module 26B by the data communication link 28. FIG. 7 illustrates the slave interface circuitry 62 located within the slave power module 26A that is used to connect with the slave power module 26B. As described above and shown in FIG. 4, the slave power module 26A includes inverting elements 82 used to invert the on/off signal 70 or the dimming signal 72 from the master power module 24 (shown in FIG. 4). As seen in FIG. 7, the inverting elements 82 both generate output signals 110 and 112. In the embodiment as shown, the output signal 110 is representative of the on/off signal 70 (FIG. 4), and the output signal 112 is representative of the dimming signal 72 (FIG. 4).

The output signals 110, 112 are each sent to a corresponding switching element 114 and an optocoupler 116 for providing electrical isolation to either the on/off signal 70 and the dimming signal 72 (shown in FIG. 4). Similar to the embodiment as shown in FIG. 4, the switching element 114 may be, for example, a MOSFET, however it is to be understood that other types of switching elements may be used as well. Moreover, the optocoupler 116 may include an LED and a phototransistor. The data communications link 28 may be used to connect the output of the optocouplers 116 with the slave power module 26A (shown in FIG. 1).

Referring generally to FIGS. 1-7, the disclosed lighting fixture 10 provide a relatively cost-effective and simple approach for controlling multiple arrays of lighting elements. Specifically, the disclosed lighting fixture 10 only includes one microcontroller and antenna that are provided within the master power module. The master power module sends the control signal to one or more slave power modules. The control signal instructs the slave power modules as to a specific lighting command (e.g., dim, turn on, turn off, etc.). Some other types of lighting fixtures currently available utilize multiple microcontrollers and antenna elements. In contrast, the disclosed lighting fixture 10 only includes a single microcontroller and antenna element that is used to provide control to every lighting array, which in turn reduces complexity and cost.

While the forms of apparatus and methods herein described constitute preferred embodiments of this invention, it is to be understood that the invention is not limited to these precise forms of apparatus and methods, and the changes may be made therein without departing from the scope of the invention.

What is claimed is:

1. A lighting fixture, comprising:
a plurality of lighting arrays;
a master power module for providing power and control to one of the plurality of lighting arrays, wherein the master power module transmits a control signal;
a data communications link for transmitting the control signal; and
at least one slave power module for providing power and control to another one of the plurality of lighting arrays based on the control signal from the master power module, wherein the data communications link connects the master power module to the slave power module.

2. The lighting fixture of claim 1, wherein the data communications link is a multi-conductor cable.

3. The lighting fixture of claim 1, wherein the master power module includes a microcontroller.

4. The lighting fixture of claim 1, wherein the master power module includes an antenna element.

5. The lighting fixture of claim 1, further comprising a plurality of slave power modules.

6. The lighting fixture of claim 5, wherein a selected one of the plurality of slave power modules receives the control signal from the master power module, and wherein the selected one of the plurality of slave power modules sends the control signal to another one of the plurality of slave power modules.

7. The lighting fixture of claim 1, wherein the master power module includes isolation electronics.

8. The lighting fixture of claim 7, wherein the isolation electronics include a switching element and an optocoupler.

9. The lighting fixture of claim 1, wherein the master power module includes at least one modulator and a magnetic transformer, and wherein the magnetic transformer receives the control signal from the modulator.

10. The lighting fixture of claim 9, wherein the master power module includes a plurality of modulators and a mixer, and wherein the mixer is configured to combine signals from each of the plurality of modulators.

11. The lighting fixture of claim 9, wherein the magnetic transformer is a planar transformer that is integrated onto a driver board.

12. The lighting fixture of claim 1, wherein the slave power module includes isolation electronics, and wherein the slave power module sends the control signal to a second slave power module.

13. The lighting fixture of claim 1, wherein the lighting fixture is a light emitting diode (LED) lamp.

14. The lighting fixture of claim 1, wherein the lighting fixture is a troffer.

15. The lighting fixture of claim 1, wherein the control signal includes at least one of an on signal, an off signal, and a dimming signal.

16. A light emitting diode (LED) lighting fixture, comprising:
a plurality of LED lighting arrays;
a master power module for providing power and control to one of the plurality of lighting arrays, wherein the master power module includes a microcontroller and an antenna element, and wherein the microcontroller transmits a control signal;
a data communications link for transmitting the control signal, wherein the control signal includes at least one of an on signal, an off signal, and a dimming signal; and
at least one slave power module for providing power and control to another one of the plurality of lighting arrays based on the control signal from the master power module, wherein the data communications link connects the master power module to the slave power module.

17. The LED lighting fixture of claim 16, wherein the master power module includes isolation electronics.

18. The LED lighting fixture of claim 17, wherein the isolation electronics include a switching element and an optocoupler.

19. The LED lighting fixture of claim 16, wherein the master power module includes at least one modulator and a magnetic transformer, and wherein the magnetic transformer receives the control signal from the modulator.

20. The LED lighting fixture of claim 19, wherein the master power module includes a plurality of modulators and a mixer, and wherein the mixer is configured to combine signals from each of the plurality of modulators.

21. The LED lighting fixture of claim 19, wherein the magnetic transformer is a planar transformer that is integrated onto a driver board.

22. The LED lighting fixture of claim 16, wherein the slave power module includes isolation electronics, and wherein the slave power module sends the control signal to a second slave power module.
